(19) United States
(12) Patent Application Publication
(10) Pub. No.: US 2025/0303622 A1
(43) Pub. Date: Oct. 2, 2025

(54) MATERIAL SUPPLY DEVICE, INJECTION MOLDING DEVICE, AND THREE-DIMENSIONAL MODELING DEVICE

(71) Applicant: SEIKO EPSON CORPORATION, Tokyo (JP)

(72) Inventors: Riona TODA, Shiojiri (JP); Hiroki TAKANO, Matsumoto (JP)

(21) Appl. No.: 19/090,702

(22) Filed: Mar. 26, 2025

(30) Foreign Application Priority Data
Mar. 28, 2024 (JP) 2024-053538

(51) Int. Cl. B29C 45/53; B29C 45/58; B29C 64/321; B33Y 30/00

(52) U.S. Cl. CPC B29C 45/53; B29C 45/586; B29C 64/321; B33Y 30/00

(57) ABSTRACT

A material supply device includes: an injection unit including a cylinder communicating with a nozzle and coupled to a flow path through which a plasticized material flows, and a plunger configured to move inside the cylinder, the injection unit being configured to perform a suction operation of suctioning the plasticized material from the flow path into the cylinder by moving the plunger rearward, and a feeding operation of feeding the plasticized material suctioned into the cylinder to the nozzle by moving the plunger forward. The plunger includes, in a longitudinal direction of the plunger, at least one first portion made of a material containing metal and a second portion made of a material containing a resin, a gap between the second portion and the cylinder is smaller than a gap between the first portion and the cylinder, and in the suction operation, when the plunger moves most rearward, the second portion is located within the cylinder.

The present application is based on, and claims priority from JP Application Serial Number 2024-053538, filed Mar. 28, 2024, the disclosure of which is hereby incorporated by reference herein in its entirety.

### BACKGROUND

### 1. Technical Field

The present disclosure relates to a material supply device, an injection molding device, and a three-dimensional modeling device.

### 2. Related Art

JP-A-2020-157601 discloses an injection molding device in which a molten resin in an injection cylinder is extruded by an injection plunger to be injected into a cavity of a metal mold.

There is a demand for a technique capable of preventing a molten resin from flowing back between a cylinder and a plunger when the molten resin in the cylinder is extruded by the plunger.

### SUMMARY

According to a first aspect of the present disclosure, a material supply device is provided. The material supply device includes: a plasticizing unit configured to plasticize at least a part of a material to generate a plasticized material; a nozzle configured to inject the plasticized material; and an injection unit including a cylinder communicating with the nozzle and coupled to a flow path through which the plasticized material flows, and a plunger configured to move inside the cylinder, the injection unit being configured to perform a suction operation of suctioning the plasticized material from the flow path into the cylinder by moving the plunger rearward in a direction away from the flow path, and a feeding operation of feeding the plasticized material suctioned into the cylinder to the nozzle by moving the plunger forward in a direction opposite to a first direction. The plunger includes, in a longitudinal direction of the plunger, at least one first portion made of a material containing metal and a second portion made of a material containing a resin, a gap between the second portion and the cylinder is smaller than a gap between the first portion and the cylinder, and in the suction operation, when the plunger moves most rearward, the second portion is located within the cylinder.

According to a second aspect of the present disclosure, an injection molding device is provided. The injection molding device includes: the material supply device; and a mold clamping device configured to open and close a mold into which the plasticized material is injected from the nozzle.

According to a third aspect of the present disclosure, a three-dimensional modeling device is provided. The three-dimensional modeling device includes: the material supply device; and a stage on which the plasticized material injected from the nozzle is deposited.

### BRIEF DESCRIPTION OF THE DRAWINGS

FIG. 1 is a top view showing a schematic configuration of an injection molding device.

FIG. 2 is a perspective view showing the schematic configuration of the injection molding device.

FIG. 3 is a cross-sectional view showing a schematic configuration of the material supply device.

FIG. 4 is a perspective view showing a schematic configuration of a flat screw.

FIG. 5 is a schematic plan view of a barrel.

FIG. 6 is a perspective view of a plunger.

FIG. 7 is an exploded perspective view of the plunger.

FIG. 8 is a diagram showing how the plunger moves inside a cylinder.

FIG. 9 is a diagram showing a discharge path of a waste material.

FIG. 10 is a diagram showing a schematic configuration of a three-dimensional modeling device.

### DESCRIPTION OF EMBODIMENTS

### A. First Embodiment

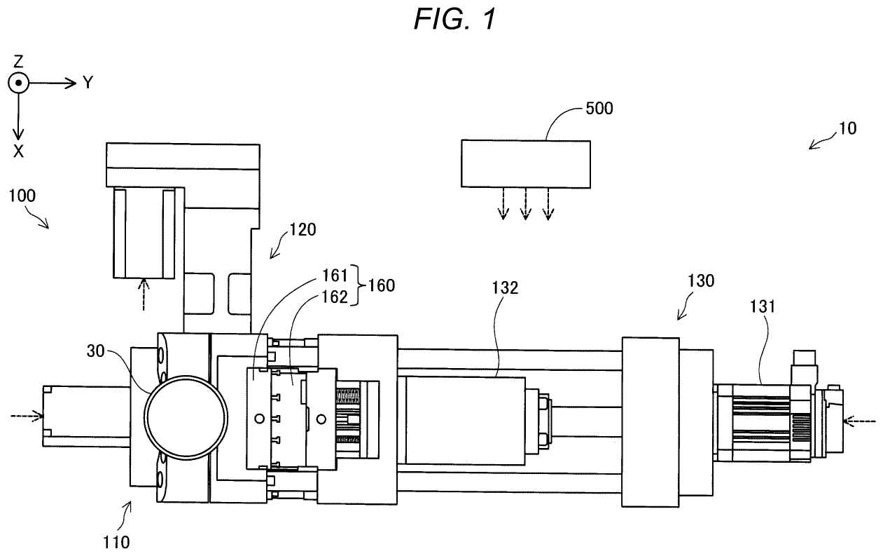

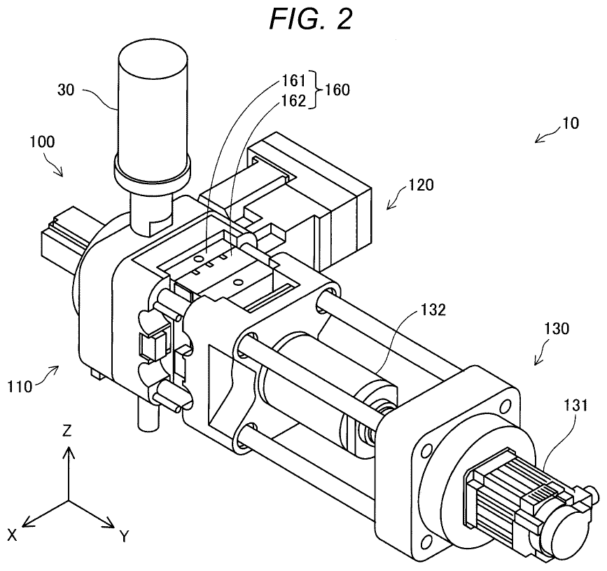

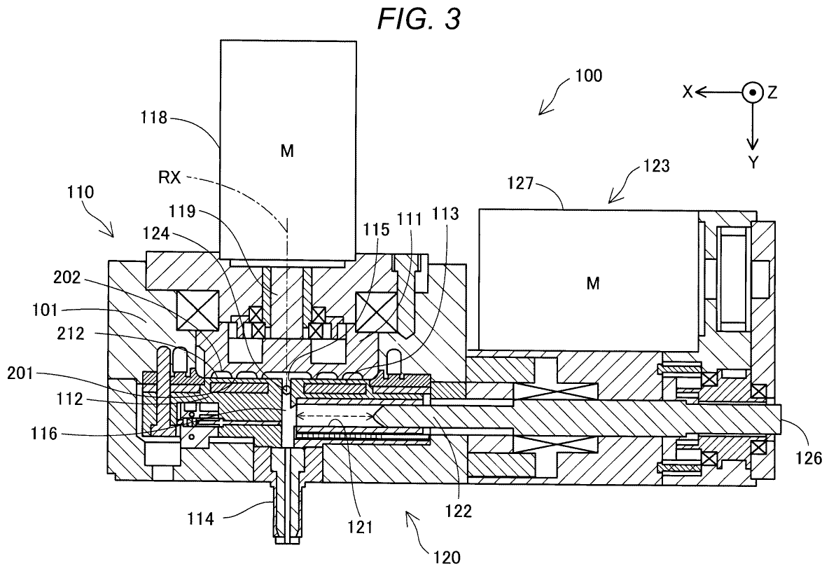

FIG. 1 is a top view showing a schematic configuration of an injection molding device 10 in a first embodiment. FIG. 2 is a perspective view showing the schematic configuration of the injection molding device 10. In FIGS. 1 and 2, arrows indicating X, Y, and Z directions orthogonal to one another are shown. The X direction and the Y direction are directions parallel to a horizontal plane, and the Z direction is a direction opposite to a direction of gravity. X, Y, and Z directions shown in FIG. 3 and thereafter correspond to the X, Y, and Z directions shown in FIGS. 1 and 2. In the following description, to specify an orientation, both positive and negative signs are used in the description of the direction, where “+” refers to a positive direction that is a direction indicated by an arrow, and “−” refers to a negative direction that is an opposite direction of the direction indicated by the arrow.

The injection molding device 10 includes a material supply device 100, a mold clamping device 130, and a control unit 500. The injection molding device 10 injects a plasticized material generated by the material supply device 100 into a mold 160 to mold a molded article. Operations of the material supply device 100 and the mold clamping device 130 are controlled by the control unit 500. The control unit 500 is implemented as a computer including a CPU and a memory, and controls each unit of the injection molding device 10 by the CPU executing a program stored in the memory. The control unit 500 may be implemented by a circuit.

The metal mold 160 is mounted on the mold clamping device 130. The mold 160 is not limited to being made of metal, and may be made of resin or ceramic. The mold 160 made of a metal is referred to as a metal mold. The mold 160 includes a fixed mold 161 and a movable mold 162. The fixed mold 161 is a mold fixed to the material supply device 100. The movable mold 162 is a mold that can be advanced and retracted in a mold clamping direction with respect to the fixed mold 161 by the mold clamping device 130. In the embodiment, the mold clamping direction is a −Y direction.

The mold clamping device 130 has a function of opening and closing the fixed mold 161 and the movable mold 162. Under the control of the control unit 500, the mold clamping device 130 drives a mold drive unit 131 implemented by a motor to rotate a ball screw 132, and moves the movable mold 162 coupled to the ball screw 132 relative to the fixed mold 161 to open and close the mold 160.

The material supply device 100 is coupled to a hopper 30 into which a material for a molded article is placed. Examples of the material for a molded article include a thermoplastic resin formed in a pellet shape. Examples of the thermoplastic resin include acrylonitrile butadiene styrene (ABS), polycarbonate (PC), polyacetal (POM), polypropylene (PP), and polybutylene terephthalate (PBT). The material for the molded article may contain metal or ceramic in addition to the thermoplastic resin. Supply of the material to the material supply device 100 is not limited to being performed via the hopper 30, and may be performed via, for example, a tube to which the material is pressure-fed.

The material supply device 100 plasticizes at least a part of the material supplied from the hopper 30 to generate a plasticized material, and injects the generated plasticized material into a cavity defined between the fixed mold 161 and the movable mold 162. In the present specification, the term “plasticize” refers to a concept including melting and means changing from a solid state to a fluid state. Specifically, in the case of a material in which glass transition occurs, plasticizing means setting a temperature of the material to be equal to or higher than a glass transition point. In the case of a material in which glass transition does not occur, plasticizing means setting the temperature of the material to be equal to or higher than a melting point.

FIG. 3 is a cross-sectional view showing a schematic configuration of the material supply device 100. The material supply device 100 includes a plasticizing unit 110 that plasticizes at least a part of the material to generate a plasticized material, a nozzle 114 that injects the plasticized material, and an injection unit 120 that communicates with the nozzle 114.

The plasticizing unit 110 includes a flat screw 111, a barrel 112, and a heater 113 as a heating unit.

The flat screw 111 is accommodated in an accommodation portion 101. The flat screw 111 is referred to as a rotor or simply as a screw. The flat screw 111 is rotated by a motor 118 in the accommodation portion 101 about a drive shaft 119 of the motor 118. A central axis

RX serving as a rotation center of the flat screw 111 coincides with a center of the drive shaft 119 of the motor 118 in an XZ plane. In the embodiment, axial directions of the drive shaft 119 and the central axis RX are along the Y direction. Rotation of the flat screw 111 by the motor 118 is controlled by the control unit 500. The flat screw 111 may be driven by the motor 118 via a speed reducer.

A communication hole 115 is formed at a center of the barrel 112. The communication hole 115 communicates with a flow path 116. A cylinder 121 and the nozzle 114 to be described later are coupled to the flow path 116. In the flow path 116, a check valve 124 is provided upstream of the cylinder 121. The check valve 124 prevents the plasticized material from flowing back from the nozzle 114 toward the flat screw 111. The heater 113 heats the barrel 112. The

heating by the heater 113 is controlled by the control unit 500. In FIG. 3, the heater 113 is disposed at a −Y direction side of the cylinder 121, but the heater 113 may be disposed at a +Z direction side or a −Z direction side of the cylinder 121. A plurality of heaters 113 may sandwich the cylinder 121 from the +Z direction side and the −Z direction side.

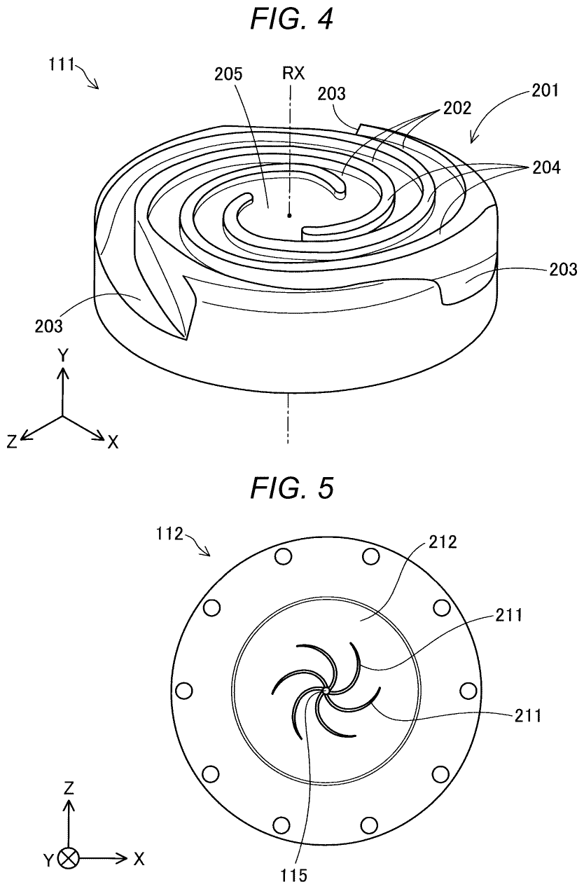

FIG. 4 is a perspective view showing a schematic configuration of the flat screw 111. The flat screw 111 has a substantially columnar shape in which a length in a direction along the central axis RX is smaller than a length in a direction perpendicular to the central axis RX. At a groove forming surface 201 facing the barrel 112, of the flat screw 111, vortex-shaped grooves 202 are formed about a center portion 205. The groove 202 communicates with a material inlet 203 formed at a side surface of the flat screw 111. A material supplied from the hopper 30 is supplied, via the material inlet 203, to the groove 202. The grooves 202 are formed by being separated by protruding portions 204. FIG. 4 shows a case where three grooves 202 are formed, and the number of grooves 202 may be one or may be two or more. The grooves 202 do not necessarily have vortex shapes and may have spiral shapes or shapes of involute curves, or may have shapes extending arcuately from the center portion 205 toward an outer circumference.

FIG. 5 is a schematic plan view of the barrel 112. The barrel 112 has an opposite surface 212 facing the groove forming surface 201 of the flat screw 111. The communication hole 115 communicating with the flow path 116 is formed in a center of the opposite surface 212. At the opposite surface 212, a plurality of guide grooves 211 coupled to the communication hole 115 and extending in a shape of a vortex from the communication hole 115 toward an outer circumference are formed. The barrel 112 may be not provided with the guide grooves 211. The guide grooves 211 may be not coupled to the communication hole 115.

The material supplied to the groove 202 of the flat screw 111 flows along the groove 202 and the guide grooves 211 due to rotation of the flat screw 111 and is guided to the center portion 205 of the flat screw 111, while being plasticized between the flat screw 111 and the barrel 112 due to the rotation of the flat screw 111 and the heating by the heater 113. The material that flows into the center portion 205 flows out into the flow path 116 through the communication hole 115 provided in the center of the barrel 112.

As shown in FIG. 3, the injection unit 120 includes the cylinder 121 that communicates with the nozzle 114 and is coupled to the flow path 116 through which the plasticized material flows, a plunger 122 that moves inside the cylinder 121, and a plunger drive unit 123. The cylinder 121 has a substantially cylindrical shape. The cylinder 121 is made of, for example, synthetic tool steel. As the synthetic tool steel, for example, SKD11 is used. The cylinder 121 is also called a sleeve. The plunger 122 has a substantially columnar shape. The plunger drive unit 123 includes a ball screw 126 that moves the plunger 122 along a longitudinal direction of the plunger 122, and a motor 127 that drives the ball screw 126. In the embodiment, when the ball screw 126 is driven by the motor 127, the plunger 122 coupled to the ball screw 126 moves forward or rearward while rotating about a central axis along a longitudinal direction of the plunger 122. “Forward” refers to a direction in which the plunger 122 approaches the flow path 116. “Rearward” refers to a direction in which plunger 122 moves away from flow path 116.

In the injection unit 120, the control unit 500 controls the plunger drive unit 123 to perform a suction operation and a feeding operation. The suction operation is an operation of suctioning the plasticized material from the flow path 116 into the cylinder 121 by moving the plunger 122 rearward. The feeding operation is an operation of feeding the plasticized material suctioned into the cylinder 121 to the nozzle 114 by moving the plunger 122 forward. The control unit 500 controls an injection amount, an injection speed, and an injection pressure of the plasticized material from the nozzle 114 by adjusting a movement amount and a movement speed of the plunger 122 in the suction operation and the feeding operation. The suction operation is also referred to as a metering operation.

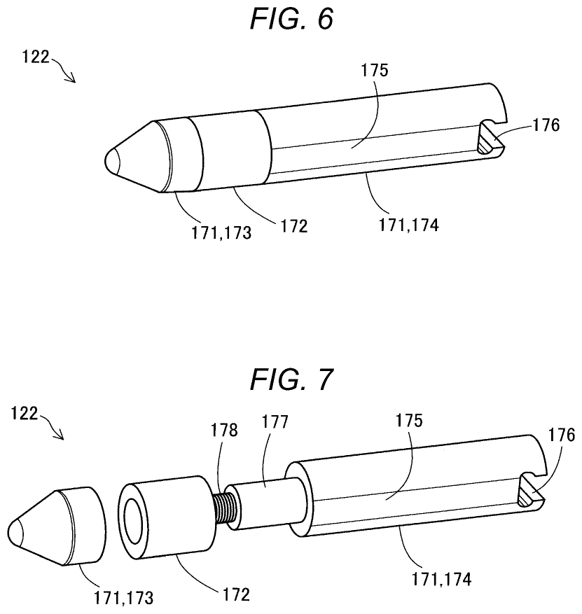

FIG. 6 is a perspective view of the plunger 122. The plunger 122 in the embodiment includes, in the longitudinal direction of the plunger 122, a first portion 171 made of a material containing metal and a second portion 172 made of a material containing a resin. The first portion 171 is made of, for example, synthetic tool steel, similar to the cylinder 121. As the synthetic tool steel, for example, SKD11 is used. The second portion 172 is made of, for example, a highly slidable resin. As the highly slidable resin, for example, polyether ether ketone (PEEK), polybenzimidazole (PBI), or polyphenylene sulfide (PPS) is used. The resin used for the second portion 172 is a resin having heat resistance to a molding temperature in the injection molding device 10.

In the embodiment, the plunger 122 includes two first portions 171 and one second portion 172. More specifically, the plunger 122 is implemented by disposing one columnar second portion 172 to be sandwiched between two first portions 171 in the longitudinal direction of the plunger 122. A diameter of the second portion 172 is larger than a diameter of the first portion 171. Hereinafter, the first portion 171 located forward of the second portion 172 is referred to as a tip end portion 173, and the first portion 171 located rearward of the second portion 172 is referred to as a rear end portion 174.

The tip end portion 173 has a substantially conical shape. The rear end portion 174 is formed in a substantially columnar shape. A flat portion 175 is provided at a side surface of the rear end portion 174 facing an inner surface of the cylinder 121. In the embodiment, two flat portions 175 are formed at the side surface of the rear end portion 174 to sandwich the central axis of the plunger 122. Each flat portion 175 extends along the longitudinal direction of the plunger 122. The flat portion 175 is also referred to as a D-cut portion. The flat portion 175 may be provided not only in the rear end portion 174 but also in the tip end portion 173. A rearmost end of the rear end portion 174 is provided with a cutout portion 176 in which a coupling member for coupling the plunger 122 to the ball screw 126 provided in the plunger drive unit 123 is fitted.

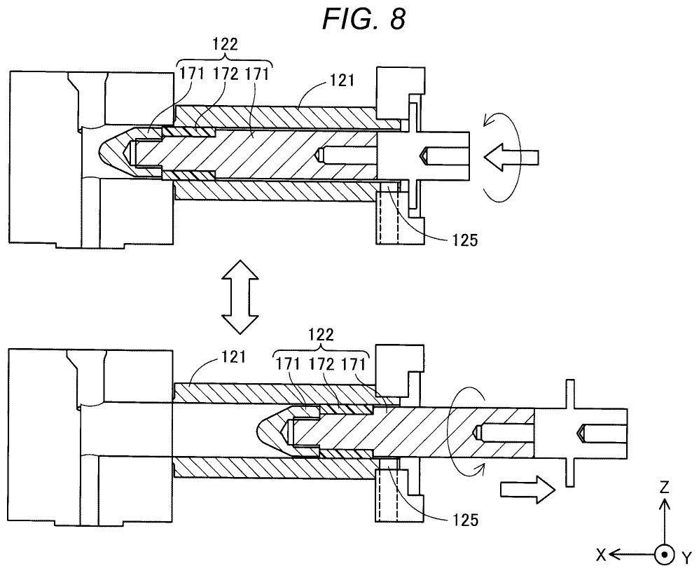

FIG. 7 is an exploded perspective view of the plunger 122. A tip end of the rear end portion 174 is provided with a small diameter portion 177 into which the second portion 172 formed in a cylindrical shape is inserted. A tip end of the small diameter portion 177 is provided with a male screw portion 178 having a smaller diameter than the small diameter portion 177. A rear end surface of the tip end portion 173 is provided with a female screw portion (not shown). The plunger 122 is assembled by screwing the female screw portion of the tip end portion 173 into the male screw portion 178 of the rear end portion 174 in a state where the cylindrical second portion 172 is inserted into the small diameter portion 177 of the rear end portion 174. Thus, in the embodiment, the second portion 172 is attachable to and detachable from the first portion 171. FIG. 8 is a view showing how the plunger 122 moves inside the cylinder 121. An upper part of FIG. 8 shows a state in which the plunger 122 is moved most forward by the feeding operation. A lower part of FIG. 8 shows a state in which the plunger 122 is moved most rearward in the suction operation. The diameter of the second portion 172 of the plunger 122 is larger than the diameter of the first portion 171. Therefore, a gap between the second portion 172 and the cylinder 121 is smaller than a gap between the first portion 171 and the cylinder 121. In the embodiment, a gap between the second portion 172 and the cylinder 121 is substantially zero. Therefore, the second portion 172 moves while being in contact with the inner surface of the cylinder 121.

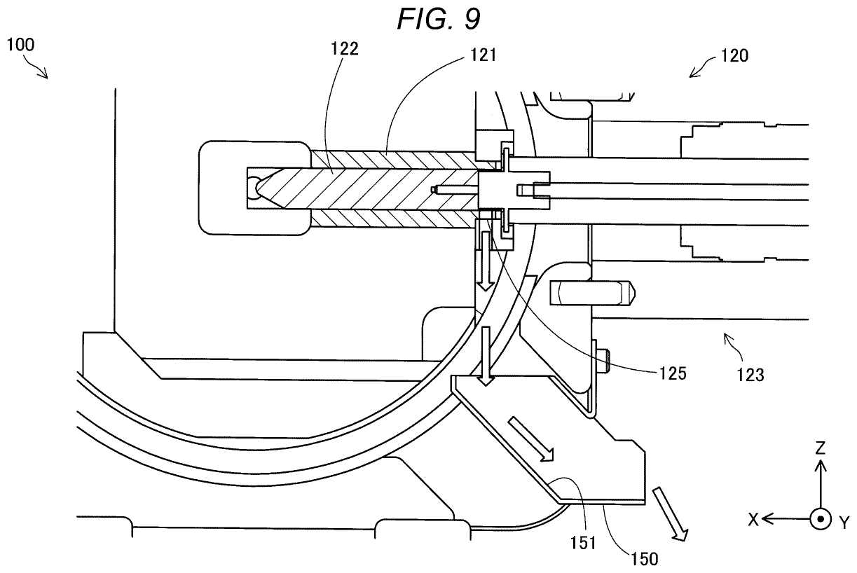

The cylinder 121 includes a discharge hole 125 for discharging a waste material in the cylinder 121. The discharge hole 125 is located rearward of the second portion 172 when the plunger 122 moves most rearward in the suction operation. The discharge hole 125 is located below the plunger 122. In the feeding operation and the suction operation of the plunger 122, the plunger 122 is rotated by the plunger drive unit 123. When the waste material adheres to the inner surface of the cylinder 121, the flat portion 175 provided at a side surface of the plunger 122 scrapes off the waste material by rotation of the plunger 122. When the plunger 122 moves rearward in the suction operation, the scraped-off waste material is pushed rearward by the second portion 172 sliding with respect to the cylinder 121, and is discharged outside the material supply device 100 from the discharge hole 125 provided below the plunger 122. FIG. 9 is a diagram showing a discharge path of

the waste material. FIG. 9 is a cross-sectional view of the material supply device 100 viewed from the nozzle 114 side. The material supply device 100 includes a guide member 150 below the discharge hole 125 that guides the waste material discharged from the discharge hole 125. The guide member 150 has an inclined surface 151. The waste material dropped from the discharge hole 125 slides and moves on the inclined surface 151 of the guide member 150 and is accommodated in a waste material container or the like disposed outside the material supply device 100.

The plunger 122 in the material supply device 100 according to the first embodiment described above includes, in the longitudinal direction thereof, the first portion 171 made of a material containing metal and the second portion 172 made of a material containing a resin. The gap between the second portion 172 and the cylinder 121 is smaller than the gap between the first portion 171 and the cylinder 121. Therefore, backflow of the plasticized material flowing back in the cylinder 121 can be prevented by the second portion 172 of the plunger 122. In general, a coefficient of thermal expansion of a resin is larger than a coefficient of thermal expansion of a metal. Therefore, during an operation of the material supply device 100, the second portion 172 undergoes greater thermal expansion than the cylinder 121, and thus the gap between the cylinder 121 and the second portion 172 can be substantially zero. Therefore, by forming the second portion 172 with a material containing a resin, a gap between the plunger 122 and the cylinder 121 can be effectively reduced. Further, in the embodiment, since the second portion 172 is made of a material containing a resin, sliding resistance of the plunger 122 can be reduced as compared with a case where the plunger 122 is made of metal similar to that of the cylinder 121. Therefore, both reduction of the sliding resistance of the plunger 122 and the prevention of the backflow can be achieved.

In the embodiment, in the suction operation, when the plunger 122 moves most rearward, the second portion 172 of the plunger 122 is located within the cylinder 121. Therefore, the second portion 172 is always located within the cylinder 121 regardless of an operation state of the plunger 122. As a result, the plasticized material can be prevented from flowing out of the material supply device 100 through the cylinder 121.

In the embodiment, in the longitudinal direction of the plunger 122, the first portion 171 containing metal is located both forward and rearward of the second portion 172 containing a resin. That is, the second portion 172 is located between the two first portions 171. Therefore, it is easy to ensure pressure resistance performance of the plunger 122 against a pressure from the flow path 116.

Since a length of the second portion 172 sliding with respect to the cylinder 121 can be reduced with respect to an entire length of the plunger 122, the sliding resistance of the plunger 122 with respect to the cylinder 121 can be reduced.

In the embodiment, the first portion 171 of the plunger 122 has the flat portion 175 at a side surface of the first portion 171, the flat portion 175 extending along the longitudinal direction of the plunger 122. Therefore, sliding resistance between the plunger 122 and the cylinder 121 can be reduced. Moreover, in the embodiment, since the plunger 122 moves while rotating in the cylinder 121, the waste material adhering to the inner surface of the cylinder 121 can be scraped off by the flat portion 175. Therefore, it is possible to reduce an increase in the sliding resistance of the plunger 122 with respect to the cylinder 121 that occurs with use of the material supply device 100.

In the embodiment, the cylinder 121 is provided with the discharge hole 125 located rearward of the second portion 172 when the plunger 122 moves most rearward in the suction operation. Therefore, the waste material present between the cylinder 121 and the plunger 122 be discharged outside the cylinder 121 from the discharge hole 125. Moreover, the material supply device 100 according to the embodiment is provided with the guide member 150 below the discharge hole 125 that guides the waste material discharged from the discharge hole 125. Therefore, the waste material can be appropriately discharged outside the material supply device 100.

In the embodiment, the second portion 172 made of a material containing a resin is attachable to and detachable from the first portion 171 made of a material containing metal. Therefore, even when the second portion 172 becomes worn, the second portion 172 can be easily replaced. Therefore, maintainability of the material supply device 100 can be improved.

### B. Second Embodiment

The material supply device 100 in the first embodiment is provided in the injection molding device 10. In contrast, the material supply device 100 is not limited to be provided in the injection molding device 10, and may be provided in, for example, a three-dimensional modeling device that injects a plasticized material from a nozzle to model a three-dimensional object.

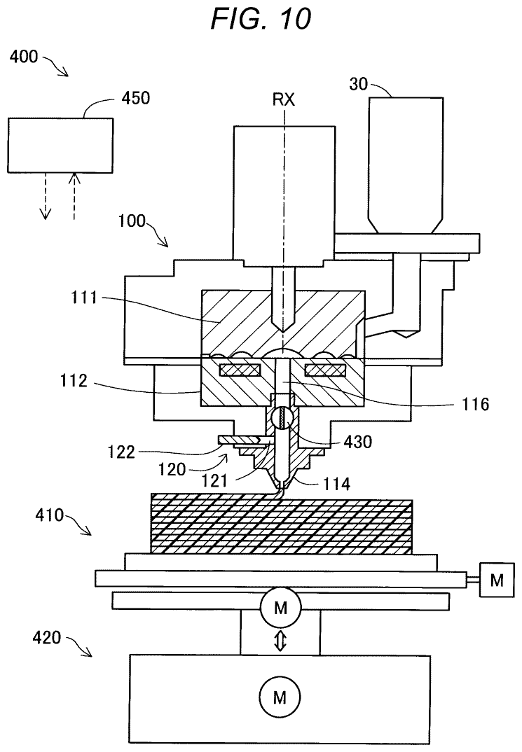

FIG. 10 is a diagram showing a schematic configuration of a three-dimensional modeling device 400. The three-dimensional modeling device 400 includes the material supply device 100, a stage 410, and a moving mechanism 420.

In the material supply device 100 according to a second embodiment, instead of the check valve 124, a valve 430 is provided in the flow path 116 for switching an amount of plasticized material extruded from the nozzle 114 or whether the plasticizing material is extruded. The valve 430 is driven under control of the control unit 450. Other configurations of the material supply device 100 are the similar as those of the material supply device 100 in the first embodiment.

The stage 410 faces the nozzle 114. A

plasticized material injected from the nozzle 114 is deposited on the stage 410. The stage 410 is supported by the moving mechanism 420.

The moving mechanism 420 changes relative positions of the nozzle 114 and the stage 410. In the embodiment, the moving mechanism 420 changes the relative positions of the nozzle 114 and the stage 410 by moving the stage 410. The moving mechanism 420 in the present embodiment is implemented by a three-axis positioner that moves the stage 410 in three axial directions, that is, the X, Y, and Z directions, by power generated by three motors. Each motor is driven under the control of the control unit 450. The moving mechanism 420 may be configured to change the relative positions of the nozzle 114 and the stage 410 by moving the material supply device 100 without moving the stage 410. The moving mechanism 420 may be configured to change the relative positions of the nozzle 114 and the stage 410 by moving both the stage 410 and the material supply device 100.

Under the control of the control unit 450, the three-dimensional modeling device 400 extrudes the plasticized material from the nozzle 114 while changing the relative positions of the nozzle 114 and the stage 410, thereby stacking layers of the plasticized material on the stage 410 to model a three-dimensional object having a desired shape. When temporarily stopping the extruding of the plasticized material from the nozzle 114 using the valve 430, the control unit 450 drives the plunger 122 to suction the plasticized material around the nozzle 114 into the cylinder 121. When the extruding of the plasticized material from the nozzle 114 is resumed using the valve 430, the plunger 122 is driven to pressure-feed the plasticized material suctioned into the cylinder 121 toward the nozzle 114.

### C. Other Embodiments

(C1) In the above embodiment, in the longitudinal direction of the plunger 122, the first portion 171 is located both forward and rearward of the second portion 172. In contrast, for example, the first portion 171 may be located only forward of or rearward of the second portion 172. Two or more first portions 171 and two or more second portions 172 may be provided in plunger 122.

(C2) In the above embodiment, the first portion 171 of the plunger 122 has the flat portion 175 on a part of the side surface. In contrast, the first portion 171 may not include the flat portion 175. The flat portion 175 is not limited to extending along the longitudinal direction of the plunger 122 in the first portion 171, and may extend in a direction intersecting the longitudinal direction of the plunger 122, for example.

(C3) In the above embodiment, the plunger 122 moves inside the cylinder 121 while rotating. In contrast, the plunger 122 may move inside the cylinder 121 without rotating.

(C4) In the above embodiment, the cylinder 121 is provided with the discharge hole 125. In contrast, the cylinder 121 may not be provided with the discharge hole 125.

(C5) In the above embodiment, the material supply device 100 includes the guide member 150 that guides the waste material discharged from the discharge hole 125. In contrast, the material supply device 100 may not include the guide member 150.

(C6) In the above embodiment, the second portion 172 of the plunger 122 is attachable to and detachable from the first portion 171. In contrast, the second portion 172 and the first portion 171 may be configured to be inseparable.

### D. Other Aspects

The present disclosure is not limited to the above-described embodiments and may be implemented with various configurations without departing from the spirit and scope of the present disclosure. For example, technical features in the embodiments corresponding to technical features in aspects described below can be replaced or combined as appropriate in order to solve a part or all of the above-described problems or in order to achieve a part or all of the above-described effects. Further, the technical features can be deleted as appropriate, unless described as essential in the present specification.

(1) According to a first aspect of the present disclosure, a material supply device is provided. The material supply device includes: a plasticizing unit configured to plasticize at least a part of a material to generate a plasticized material; a nozzle configured to inject the plasticized material; and an injection unit including a cylinder communicating with the nozzle and coupled to a flow path through which the plasticized material flows, and a plunger configured to move inside the cylinder, the injection unit being configured to perform a suction operation of suctioning the plasticized material from the flow path into the cylinder by moving the plunger rearward in a direction away from the flow path, and a feeding operation of feeding the plasticized material suctioned into the cylinder to the nozzle by moving the plunger forward in a direction approaching the flow path. The plunger includes, in a longitudinal direction of the plunger, at least one first portion made of a material containing metal and a second portion made of a material containing a resin, a gap between the second portion and the cylinder is smaller than a gap between the first portion and the cylinder, and in the suction operation, when the plunger moves most rearward, the second portion is located within the cylinder.

With such a material supply device, it is possible to prevent the plasticized material from flowing back between the cylinder and the plunger.

(2) In the above aspect, the plunger may include two first portions, and the second portion may be located between the two first portions in the longitudinal direction. According to such an aspect, it is easy to ensure pressure resistance performance of the plunger against a pressure from the flow path.

(3) In the above aspect, the first portion may have a flat portion at a side surface of the first portion facing an inner surface of the cylinder. According to such an aspect, sliding resistance between the plunger and the cylinder can be reduced.

(4) In the above aspect, the flat portion may extend along the longitudinal direction. According to such an aspect, the sliding resistance between the plunger and the cylinder can be reduced.

(5) In the above aspect, the plunger may move inside the cylinder while rotating about a central axis along the longitudinal direction. According to such an aspect, the waste material adhering to the inner surface of the cylinder can be scraped off by the flat portion.

(6) In the above aspect, the cylinder may have a discharge hole located rearward of the second portion when the plunger moves most rearward in the suction operation. According to such an aspect, the waste material present between the cylinder and the plunger can be discharged outside the cylinder from the discharge hole.

(7) In the above aspect, a guide member below the discharge hole configured to guide a waste material discharged from the discharge hole may be provided. According to such an aspect, the waste material can be appropriately discharged outside the material supply device.

(8) In the above aspect, the second portion may be attachable to and detachable from the first portion. According to such an aspect, even when the second portion becomes worn, the second portion can be easily replaced.

(9) According to a second aspect of the present disclosure, an injection molding device is provided. The injection molding device includes: the material supply device; and a mold clamping device configured to open and close a mold into which the plasticized material is injected from the nozzle.

(10) According to a third aspect of the present disclosure, a three-dimensional modeling device is provided. The three-dimensional modeling device includes: the material supply device; and a stage on which the plasticized material injected from the nozzle is deposited.

What is claimed is:

1. A material supply device comprising:
a plasticizing unit configured to plasticize at least a part of a material to generate a plasticized material;
a nozzle configured to inject the plasticized material; and
an injection unit including a cylinder communicating with the nozzle and coupled to a flow path through which the plasticized material flows, and a plunger configured to move inside the cylinder, the injection unit being configured to perform a suction operation of suctioning the plasticized material from the flow path into the cylinder by moving the plunger rearward in a direction away from the flow path, and a feeding operation of feeding the suctioned into the cylinder to the plasticized material nozzle by moving the plunger forward in a direction approaching the flow path, wherein
the plunger includes, in a longitudinal direction of the plunger, at least one first portion made of a material containing metal and a second portion made of a material containing a resin,
a gap between the second portion and the cylinder is smaller than a gap between the first portion and the cylinder, and
in the suction operation, when the plunger moves most rearward, the second portion is located within the cylinder.

2. The material supply device according to claim 1, wherein
the plunger includes two first portions, and
the second portion is located between the two first portions in the longitudinal direction.

3. The material supply device according to claim 1, wherein
the first portion has a flat portion at a side surface of the first portion facing an inner surface of the cylinder.

4. The material supply device according to claim 3, wherein
the portion extends along the t longitudinal direction.

5. The material supply device according to claim 3, wherein
the plunger moves inside the cylinder while rotating about a central axis along the longitudinal direction.

6. The material supply device according to claim 1, wherein
the cylinder has a discharge hole located rearward of the second portion when the plunger moves most rearward in the suction operation.

7. The material supply device according to claim 6, further comprising:
a guide member below the discharge hole configured to guide a waste material discharged from the discharge hole.

8. The material supply device according to claim 1, wherein
the second portion is attachable to and detachable from the first portion.

9. An injection molding device comprising:
the material supply device according to claim 1; and
a mold clamping device configured to open and close a mold into which the plasticized material is injected from the nozzle.

10. A three-dimensional modeling device comprising:
the material supply device according to claim 1; and
a stage on which the plasticized material injected from the nozzle is deposited.
